(19) United States
(12) Patent Application Publication
(10) Pub. No.: US 2025/0166880 A1
(43) Pub. Date: May 22, 2025

(54) MULTISIDED MAGNETIC FILMS ON THIN CORE INDUCTORS

(71) Applicants: Applied Materials, Inc., Santa Clara, CA (US); The Florida International University Board of Trustees, Miami, FL (US)

(72) Inventors: Mohammad Mohtasim Hamid Pial, Miami, FL (US); Mudit Sunilkumar Khasgiwala, Milpitas, CA (US); Markondeyaraj Pulugurtha, Miami, FL (US); Subramani Kengeri, Saratoga, CA (US); Kunal Ghosh, Bengaluru (IN); Meghna Maheshkumar Patel, Navsari (IN); Sachin Jayant Patil, Bengaluru (IN); Arvin Khosravi, Los Gatos, CA (US)

(73) Assignees: Applied Materials, Inc., Santa Clara, CA (US); The Florida International University Board of Trustees, Miami, FL (US)

(21) Appl. No.: 18/512,941

(22) Filed: Nov. 17, 2023

(51) Int. Cl. H01F 27/24; H01F 27/28; H01F 27/32; H01F 41/04

(52) U.S. Cl. CPC H01F 27/24; H01F 27/2804; H01F 27/2895; H01F 27/324; H01F 41/042; H01F 41/043

(57) ABSTRACT

An inductor may include a flexible polyimide flexible core may including one or more cavities. The inductor may include a magnetic film, formed on two sides of the flexible polyimide flexible core and on a respective sidewall of each of the one or more cavities. The inductor may include a dielectric layer formed on the magnetic film. The inductor may also include a metal layer formed on the dielectric layer and within the cavities, such that vias are formed on one or more sides of the inductor and extend through the one or more cavities.

### TECHNICAL FIELD

The present technology relates to semiconductor systems, processes, and equipment.

More specifically, the present technology relates to inductors and methods of manufacturing thereof.

### BACKGROUND

Modern electronic devices require discrete inductors to perform many functions. As the performance requirements of the electronic devices increase, so does the need for inductors that can provide a high inductance for the space and inductor takes within the device. Furthermore, the inductors also need to be able to provide better performance in handling currents at the power levels and/or frequencies used in the electronic devices.

### BRIEF SUMMARY

An inductor may include a flexible polyimide flexible core may including one or more cavities. The inductor may include a magnetic film, formed on two sides of the flexible polyimide flexible core and on a respective sidewall of each of the one or more cavities. The inductor may include a dielectric layer formed on the magnetic film. The inductor may also include a metal layer formed on the dielectric layer and within the cavities, such that vias are formed on one or more sides of the inductor and extend through the one or more cavities.

In some embodiments, the magnetic film may include nickel, iron, cobalt, zirconia, and tantalum, hafnium, and silicon. The magnetic film may include an oxide of at least one of zirconium, tantalum, hafnium, silicon. The magnetic film may include multiple layers of magnetic films and oxide films. The metal layer and the vias form between two and five turns, inclusive, of the inductor. The inductor may include an airgap in the flexible polyimide core, the air gap may including a width of about 48 micrometers to about 250 micrometers.

An inductor may include a polyimide flexible core. The inductor may include a magnetic film, deposited on one or more sides of the flexible core. The inductor may include a dielectric layer. The inductor may further include a plurality of copper windings.

In some embodiments, the magnetic film may include at least one of cobalt, zirconia, and tantalum. The magnetic film may include an oxide layer. In some embodiments, the plurality of copper windings may form a toroidal shape. The toroid may include an airgap.

A method of forming an inductor may include forming a magnetic film on a flexible core. The method may also include forming a dielectric layer on the magnetic film. The method may then include and forming a metal layer on at least some of the dielectric layer.

In some embodiments, first vias may be formed through the flexible core prior to depositing the magnetic film on the flexible core. The method may include forming second vias through the dielectric layer such that depositing the metal layer on at least some of the dielectric layer forms a metal pathway extending through at least one of the flexible core, the magnetic film, and the dielectric layer. The first vias may include a diameter of about 25 micrometers. The magnetic film has a thickness of about 10 micrometers. The magnetic film, the dielectric layer and a metal seeding layer may be sequentially deposited in a same PVD sequence. The flexible core may include polymide, glass, liquid crystal polymer, and fluoropolymer. The method may also include forming an airgap in the metal layer, and the airgap is filled with heavily-loaded magnetic paste.

### BRIEF DESCRIPTION OF THE DRAWINGS

FIG. 1 illustrates a flowchart of a method for forming an inductor, according to certain embodiments.

FIGS. 2A-2F illustrate a process flow of the method for forming an inductor, according to certain embodiments.

FIG. 3 illustrates a cross sectional view of an inductor with an airgap, according to certain embodiments.

FIG. 4A illustrates a toroidal inductor with four windings, according to certain embodiments.

FIG. 4B illustrates a toroidal inductor with six windings, according to certain embodiments.

FIG. 4C illustrates a toroidal inductor with four angled windings, according to certain embodiments.

FIG. 4D illustrates a toroidal inductor with four windings, according to certain embodiments.

FIG. 4E illustrates a toroidal inductor with four angled windings, according to certain embodiments.

FIG. 5 illustrates an exemplary computer system, in which various embodiments may be implemented.

### DETAILED DESCRIPTION

Voltage regulators with integrated magnetics may be an important component of current and future electronic devices for high-performance computing and communication systems. These are integrated with various system hardware integration architectures such as System on a Chip (SOC) technologies, advanced multichip, multichiplet or heterogeneous-integrated packages, and other such devices. Some of all of these devices may require high frequency switching regulators for high efficiency and granular power delivery where the power supply is optimized for each domain within an integrated circuit (IC). Commonly available inductors may experience current ripple and/or direct current (DC) losses at or near operating frequencies of such device. An integrated inductor, included in such a device may reduce the current ripple and/or DC losses by utilizing multiphase switching close to the active circuits. One way to increase the inductance of an integrated inductor is to increase the number of windings (generally copper) included in the inductor. As the number of windings increases, however, the resistance also increases. Furthermore, the amount of current ripple or drift may also increase. Minimizing the number of copper windings in an integrated inductor may address some of these issues.

High-performance inductors need good properties. Such films are only formed at smaller thicknesses that render them very ineffective. This is the main challenge faced by the industry. We disclose unique multiside films on thin cores to address this grand challenge.

The maximum current that an inductor can handle is directly related to the reluctance of the magnetic core, while inductance is inversely related to the reluctance. Reluctance is directly proportional to the length of the core and inversely related to the cross-sectional area. Toroidal inductors with an airgap may provide lowest reluctance and high inductance. A relatively thick magnetic core may further increase the inductance without increasing the footprint or coil length of the inductors. To form such inductors, nanomagnetic films (sometimes “magnetic films”) may be deposited on multiple sides of a flexible core to form an integrated passive devices. In order to control the thickness, these are deposited on thin substrate cores. (these are labeled as multisided magnetic films on thin cores, MTCs). The flexible core may include cavities or vias, that pass through the flexible core. Vias may also be referred to as a type of cavity. The MTC with an isolation layer may then be formed and the MTC may be planarized. Then, a metal layer may be formed on the MTC (e.g., via plating). This process may offer several benefits. For example, the process (or “MTC approach”) may eliminate several integration issues with patterning toroid with an airgap as the vias are drilled before the metal layer is formed. The process may also enhance throughput because of the multi-sided sputtering. Inductors formed from the above process may offer performance benefits such as higher current-handling and efficiency due in part to the multi-sided deposition. The process benefits also include thicker copper plating on either side to result in lower DC resistance for higher current-handling. The processes and devices disclosed herein may be used to create inductors using such an MTC approach, thereby creating inductors with improved performance (e.g., lower current ripple and DC resistance).

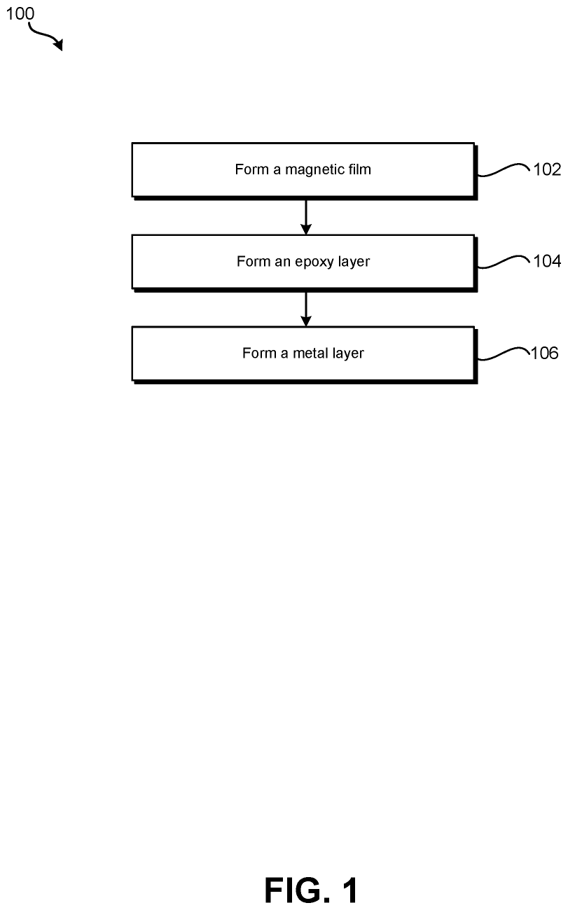

FIG. 1 illustrates a flowchart of a method 100 for forming an inductor, according to certain embodiments. Steps of the method 100 may be performed in a different order than is shown in FIG. 1 and/or combined with other steps of the method 100. In some embodiments, some of the steps of the method 100 may be skipped altogether.

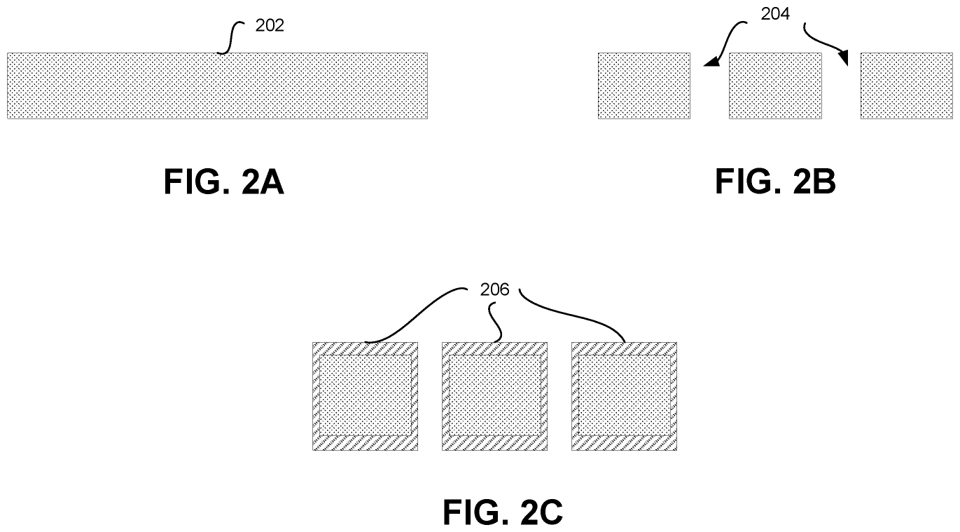

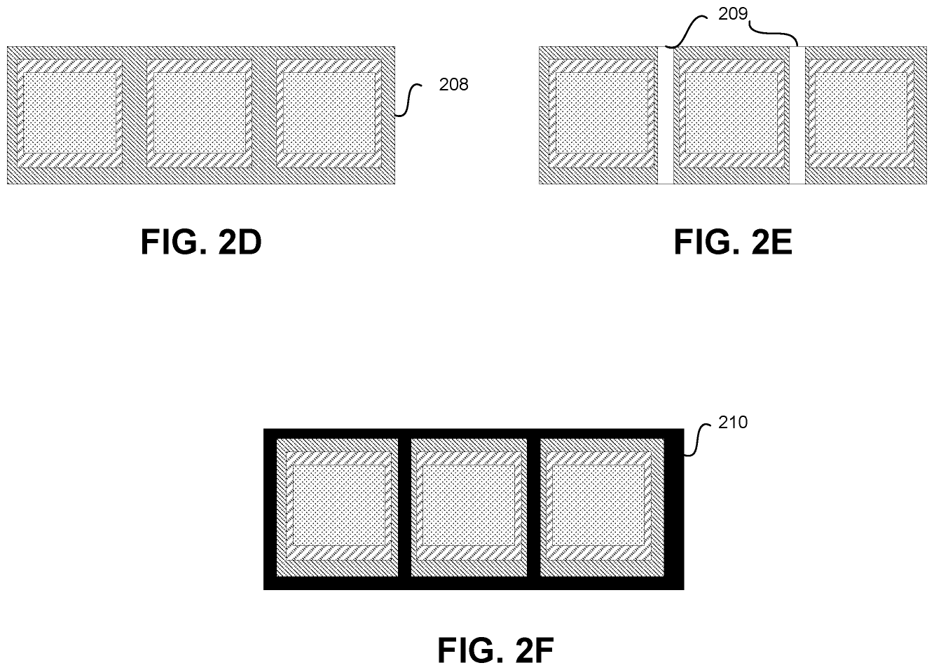

At step 102, the method 100 may include forming a magnetic film 206 on a flexible core 202. In FIG. 2A, a flexible core 202 may be provided. The flexible core 202 may comprise polyimide, glass, liquid crystal polymer, fluoropolymer, Molypermalloy powder cores, High Flux, kool Mu®/Sendust, or other suitable core materials. The flexible core 202 may have a thickness of about 15 μm, about 20 μm, about 30 μm, about 35 μm, or about 40 μm. The flexible core 202 may be an “off-the-shelf” product or may be manufactured as part of the method 100. During a manufacturing process, the flexible core 202 may be supported by a framework, grid frame, or other suitable device. The framework may provide a template for features to be formed on the flexible core 202, such as patterning for a deposition or etching process, guides holes for drilling or ablation, and/or any other such process.

As shown in FIG. 2B, first vias 204 may be formed in the flexible core 202. The first vias 204 may be formed using a laser, mechanical drill, or formed via an etching and/or ablation process. The first vias 204 may include a diameter of about 10 μm, about 15 μm, about 20 μm, about 25 μm, about 30 μm, about 40 μm, about 50 μm, about 60 μm, and/or about 70 μm. In some embodiments, all of the first vias 204 include the same diameter. In other embodiments, the first vias 204 may include different diameters. In either case, the first vias 204 may extend through a top and bottom side of the flexible core 202.

As shown in FIG. 2C, the magnetic film 206 may be formed on multiple sides of the flexible film 202. The magnetic film 206 may be formed on sidewalls of the first vias 204. The magnetic film may be deposited to a thickness of about 10 μm, about 15 μm, about 20 μm, about 25 μm, or about 30 μm. The magnetic film 206 may include nickel, iron, cobalt, zirconia, tantalum, and/or any other suitable material. The magnetic film 206 may include a single material or may include combinations and alloys of any or all of the aforementioned materials. In some embodiments, the magnetic film 206 may be formed by sputtering one or more materials on the flexible core 202. In other embodiments, the magnetic film 206 may be formed by other physical vapor deposition (PVD) techniques such as e-beam evaporation, atomic layer deposition (ALD), or any other type of deposition. In some embodiments, multiple layers of magnetic film 206 may deposited via sputtering. The multiple layers of magnetic film 206 may been interspersed with a thin oxide of a material such as zirconia, silica or others. In some embodiments, a single oxide layer may be formed on the magnetic film 206. The single oxide layer 206 may serve as a dielectric and aid in isolating the magnetic film 206 from other layers of the inductor.

At step 104, the method 100 may include forming a dielectric layer 208 on the magnetic film 206, as shown in FIG. 2D. The dielectric layer 208 may include materials such as epoxy, polyimide, silicones, and/or siloxanes. The dielectric layer 208 may be formed to a thickness of about 5 μm, about 10 μm, about 15 μm, or about 20 μm. The dielectric layer 208 may be formed on the top side and bottom side of the flexible core 202. The dielectric layer 208 may also be formed in the first vias 204. The dielectric layer 208 may completely or partially fill some or all of the first vias 204. Thus, the dielectric layer 208 may isolate the flexible core 202 and the magnetic film 206. The flexible core 202 and the magnetic film 206 may therefore be thought of as a magnetic core of the inductor.

The dielectric layer 208 may include one or more polymers or other suitable materials. The dielectric layer 208 may include a dielectric material such as polypropylene, cyclic transparent optical fluoropolymer (CYTOP), polypropylene-co-1-butene, or other suitable polymers and/or materials. The dielectric layer 208 may planarize the magnetic film 206. For example, forming the magnetic film 206 may create imperfections or an uneven surface. The dielectric layer 208 may be formed such that the imperfections are filled in and/or such that a surface of the dielectric layer 208 is even.

In some embodiments, the method may include forming second vias 209 through the dielectric layer 208, as shown in FIG. 2E. The second vias 209 may correspond to the first vias 204, passing through the same pathway as the first vias 204. Thus, each of the second vias 209 be a cavity surrounded by a dielectric layer (e.g., the dielectric layer 208) and the magnetic film 206. The second vias 209 may be formed using a laser, mechanical drill, or formed via an etching and/or ablation process. The second vias 209 may include a diameter of about 10 μm, about 15 μm, about 20 μm, about 25 μm, about 30 μm, about 40 μm, and/or about 50 μm.

At step 106, the method 100 may include forming a metal layer 210 on at least a portion of the dielectric layer 208, as shown in FIG. 2F. The metal layer 210 may include copper, silver, nickel, and/or any other suitable metal. The metal layer 210 may be formed via PVD, ALD, sputtering, and/or other suitable deposition processes. The metal layer 210 may additionally or alternatively be formed via an electroplating process. For example, the metal layer 210 may be formed by depositing a metal seeding layer via PVD, then electroplating the metal layer 210 on the metal seeding layer. The metal layer 210 may be formed to a thickness of about 5 μm, about 10 μm, about 15 μm, about 20 μm, or about 30 μm.

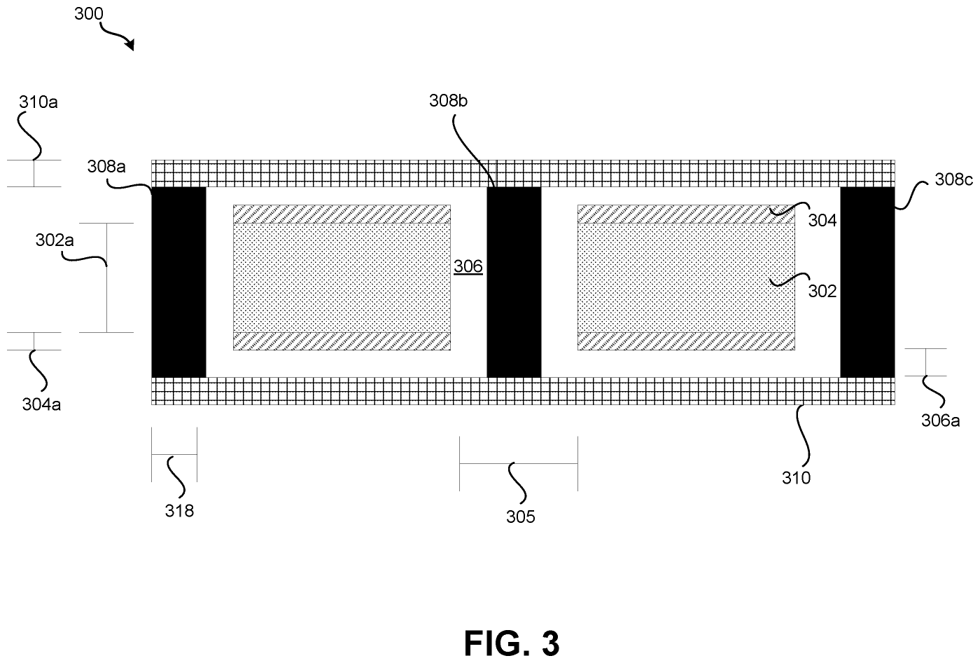

The metal layer 210 may be formed on the top side and the bottom side of the inductor and within the second vias 209 such that the second vias 209 mare completely filled. The metal layer 210 may therefore form windings (e.g., a copper winding) surrounding the magnetic core (e.g., the flexible core 202 and the magnetic film 206). The windings and the magnetic core may form components of the inductor (such as the inductor 200 in FIG. 3). The dielectric layer 208 may isolate the magnetic core from the windings, improving the performance of the inductor. In some embodiments, the windings may form a toroidal shape. As discussed above, a toroidal shape may provide for greater inductance and/or other performance metrics of an inductor.

The metal layer 210 may be formed via electroplating. Thick and low-resistance copper structures may be created utilizing standard plating formulations. The electroplating may utilize a current bus plane that is either deposited with PVD (e.g., sputtering) or a chemical solution processing (electroless plating). Since the current bus plane facilitates the plating of copper by acting as a seed, this plane may be referred to as a seed layer. If the seed layer is deposited by a sputtering process, the seed layer offers certain advantages with tool supply chain management as the magnetic film 206, isolation layer (e.g., an oxide layer. A dielectric layer, etc.) and seeding may be formed in the same tool or toolset at semiconductor foundry level.

FIG. 3 illustrates a cross sectional view of an inductor 300 with an airgap 305, according to certain embodiments. The inductor 300 may be formed by a process, such as is described in relation to the method 100 in FIG. 1 and in FIGS. 2A-2F. The inductor 300 may therefore include similar properties and components described therein. The inductor 300 may include a flexible core 302, a magnetic film 304, an isolation layer 306, metal pathways 308a-c, and metal layer 310. The flexible core 302 and the magnetic film 304 may form a magnetic core of the inductor 300. The flexible core 302 may include polyimide and/or any other suitable material for forming a flexible core. The flexible core 302 may include a core thickness 302a. The core thickness 302a may be about 30 μm. In other embodiments, the core thickness 302a may be about 15 μm, about 20 μm, about 35 μm, or about 40 μm.

The magnetic film 304 may include nickel, iron, cobalt, zirconia, tantalum, hafnium, silicon and/or any other suitable material. The magnetic film 304 may additionally or alternatively include oxygen and at least one of include nickel, iron, cobalt, zirconia, tantalum, hafnium, silicon and/or any other suitable material. The magnetic film 304 may include a single material or may include combinations and alloys (e.g., a cobalt alloy) of any or all of the aforementioned materials. The magnetic film 304 may include a film thickness 304a. The film thickness 304a may be about 15 μm. In other embodiments, the film thickness 304a may be about 10 μm, about 20 μm, about 25 μm, or about 30 μm.

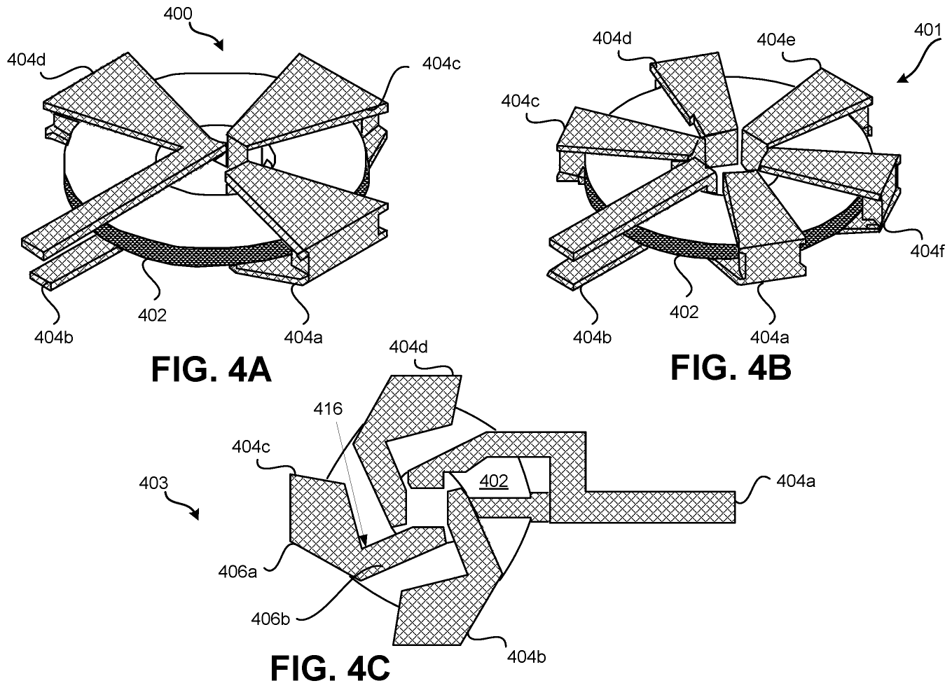

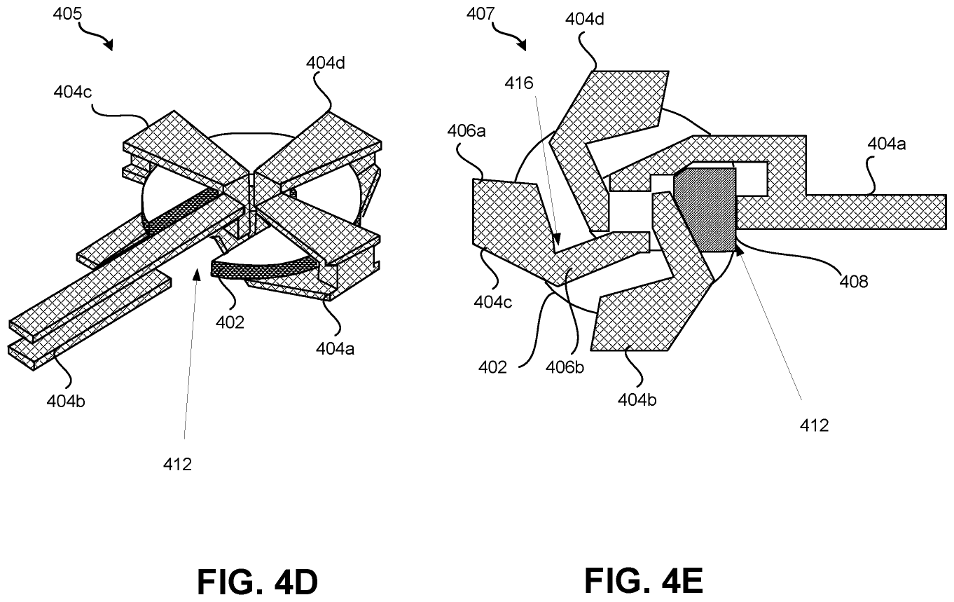

The magnetic core of the inductor 300 (i.e., the flexible core 302 and the magnetic film 304) may be substantially round, rectangular, or any other suitable shape. The magnetic core may also include an airgap 305. The airgap 305 may be formed in the flexible core 302 prior to forming the magnetic film 304. The airgap 305 may be formed via etching, laser cutting ablation, or any other suitable method. In relation to FIG. 3, the magnetic core may extend into the page, forming a partial disk. The two sides of the magnetic core shown in FIG. 3 may therefore be a unitary piece, with the airgap 305 in one side of the partial disk. A top down view of a similar magnetic core may be seen in FIG. 4D. The airgap 305 may have a width of about 120 μm. In other embodiments, the airgap 305 may include a width of about 80 μm, about 90 μm, about 100 μm, about 150 μm, or about 200 μm.

The isolation layer 306 may be similar to the dielectric layer 208 in FIGS. 2C-2F. The isolation layer 306 may accordingly include a dielectric material, as described above. The isolation layer 306 may also include an oxide formed on the magnetic film 304. The isolation layer 306 may fill the airgap 305. In some embodiments, the airgap 305 may not include the isolation layer 306. The isolation layer 306 may include a dielectric thickness 306a. The dielectric thickness 306a may be about 10 μm. In other embodiments, the dielectric thickness 306a may be about 5 μm, about 15 μm, or about 20 μm. The isolation layer 306 may be uniform, having the same dielectric thickness 306a in all regions. In other embodiments, the isolation layer 306 may include different dielectric thicknesses 306a in different regions (e.g., the dielectric thickness within airgap 305 may be different than the dielectric thickness on the bottom side of the inductor 300).

The metal pathways 308a-c may include copper and may extend through the top side and the bottom side of the magnetic core and the isolation layer 306. The metal pathways 308a-c may include a via width 318. The via width 318 may be about 36 μm. In other embodiments, the via width 318 may be about 20 μm, about 30 μm, about 40 μm, or about 50 μm. The metal pathways 308a-c may be formed as part of and/or be connected to the metal layer 310. The metal layer 310 may also include copper. The metal layer 310 may include a metal thickness 310a of about 15 μm. In other embodiments, the metal thickness 310a may be about 5 μm, about 10 μm, about 20 μm, or about 30 μm.

The isolation layer 306 may impact later stages of processing and also the currenthandling of the inductor 300 by increasing the reluctance thereof. Thicker polymer isolation may create good reluctance and include a conformal polymer coating or complete polymer fill, followed by the drilling of an inner via. Thus, a PVD process of depositing the magnetic film may be disrupted by adding another PVD process to form a polymer coating or lamination. In some embodiments, the isolation layer 306 may include an oxide film also deposited through a PVD process. Since the metal winding is created with a PVD seeding process, this approach has an advantage. All the PVD steps are sequentially deposited with PVD without disrupting to add a polymer lining. In other words, the magnetic film 304, the isolation layer 306, and the metal seeding layer may be formed sequentially by a single PVD sequence.

The metal pathways 308a-c and the metal layer 310 may form copper windings about the magnetic core. The copper windings may pass through vias or cavities through the magnetic core and the isolation layer 306. As described above, the magnetic core may be a disc (or partial disk). The copper windings may therefore form a toroid about the magnetic core. In other words, the inductor 300 may be a toroidal inductor and include the airgap 305. Thus, the inductor 300 may have better inductance and lower current ripple and DC resistance as compared to other inductors.

FIG. 4A illustrates a toroidal inductor 400 with four windings 404a-d, according to certain embodiments. The toroidal inductor 400 may be similar to the inductor 300 in FIG. 3 and include similar features, measurements, and capabilities. The toroidal inductor 400 may be formed by a process such as the method 100 in FIG. 1 and FIGS. 2A-2F. The toroidal inductor 400 may include a magnetic core 402 and the windings 404a-d. The magnetic core 402 may be disc-shaped and include a pathway in the center. The magnetic core 402 may include a flexible core and a magnetic film, such as the flexible core 302 and the magnetic film 304 in FIG. 3.

The windings 404a-d may be separated at regular radial intervals about the center of the magnetic core 402. For example, the windings 404a-d may be disposed every 900 about the magnetic core 402. One or more of the windings 404a-d (e.g., the winding 404b) may be connected to a power source (not pictured). The power source may provide an alternating current or a DC to the windings 404a-d such that the toroidal inductor 400 operates according to design (e.g., as a high switching regulator).

FIG. 4B illustrates a toroidal inductor 401 with six windings 404a-f, according to certain embodiments. The toroidal inductor 401 may be similar to the inductor 300 in FIG. 3 and include similar features, measurements, and capabilities. The toroidal inductor 401 may be formed by a process such as the method 100 in FIG. 1 and FIGS. 2A-2F. The toroidal inductor 401 may include a magnetic core 402 and the windings 404a-f. The magnetic core 402 may be disc-shaped and include a pathway in the center. The magnetic core 402 may include a flexible core and a magnetic film, such as the flexible core 302 and the magnetic film 304 in FIG. 3.

The windings 404a-f may be separated at regular radial intervals about the center of the magnetic core 402. For example, the windings 404a-f may be disposed every 60° about the magnetic core 402. One or more of the windings 404a-f (e.g., the winding 404b) may be connected to a power source (not pictured). The power source may provide an alternating current or a DC to the windings 404a-f such that the toroidal inductor 400 operates according to design (e.g., as a high switching regulator).

FIG. 4C illustrates a toroidal inductor 403 with four angled windings 404a-d, according to certain embodiments. The toroidal inductor 403 may be similar to the inductor 300 in FIG. 3 and include similar features, measurements, and capabilities. The toroidal inductor 403 may be formed by a process such as the method 100 in FIG. 1 and FIGS. 2A-2F. The toroidal inductor 403 may include a magnetic core 402 and the angled windings 404a-d. The magnetic core 402 may be disc-shaped and include a pathway in the center. The magnetic core 402 may include a flexible core and a magnetic film, such as the flexible core 302 and the magnetic film 304 in FIG. 3.

The angled windings 404a-d may be separated at regular radial intervals about the center of the magnetic core 402. For example, the angled windings 404a-d may be disposed every 60° about the magnetic core 402. One or more of the angled windings 404a-d (e.g., the angled winding 404a) may be connected to a power source (not pictured). The power source may provide an alternating current or a DC to the angled windings 404a-d such that the toroidal inductor 400 operates according to design (e.g., as a high switching regulator).

The angled windings 404a-d may include a first arm 406a and a second arm 406b. Although only the angled winding 404c is labelled with the first arm 406a and the second arm 406b, it should be understood that all of the angled windings 404a-d may include a first arm and a second arm. The first arm 406a and second arm 406b may meet to form an angle 416. The angle 416 may be within a range of about 600 to about 120°, inclusive. The first arm 406a and the second arm 406b may increase a surface area of the angled winding 404c and/or the overall length of the angled winding 404c. Thus, the toroidal inductor 403 may exhibit different operating characteristics than other inductors (e.g., operating frequency, inductance, reluctance, etc.).

FIG. 4D illustrates a toroidal inductor 405 with four windings 404a-d, according to certain embodiments. The toroidal inductor 405 may be similar to the inductor 300 in FIG. 3 and include similar features, measurements, and capabilities. The toroidal inductor 405 may be formed by a process such as the method 100 in FIG. 1 and FIGS. 2A-2F. The toroidal inductor 405 may include a magnetic core 402 and the windings 404a-d. The magnetic core 402 may be disc-shaped and include a pathway in the center. The magnetic core 402 may include a flexible core and a magnetic film, such as the flexible core 302 and the magnetic film 304 in FIG. 3.

The magnetic core 402 may also include an airgap 412. The airgap 412 may be similar to the airgap 305 in FIG. 3. Thus, the airgap 412 may be formed as part of a production process of the flexible core and/or formed through an etching process, cutting process (e.g., laser cutting), ablation, or any other suitable method.

The windings 404a-d may be separated at regular radial intervals about the center of the magnetic core 402. For example, the windings 404a-d may be disposed every 90° about the magnetic core 402. One or more of the windings 404a-d (e.g., the winding 404b) may be connected to a power source (not pictured). The power source may provide an alternating current or a DC to the windings 404a-d such that the toroidal inductor 405 operates according to design (e.g., as a high switching regulator).

FIG. 4E illustrates a toroidal inductor 407 with four angled windings 404a-d, according to certain embodiments. The toroidal inductor 407 may be similar to the inductor 300 in FIG. 3 and include similar features, measurements, and capabilities. The toroidal inductor 407 may be formed by a process such as the method 100 in FIG. 1 and FIGS. 2A-2F. The toroidal inductor 407 may include a magnetic core 402 and the angled windings 404a-d. The magnetic core 402 may be disc-shaped and include a pathway in the center. The magnetic core 402 may include a flexible core and a magnetic film, such as the flexible core 302 and the magnetic film 304 in FIG. 3.

The magnetic core 402 may also include an airgap 412. The airgap 412 may be similar to the airgap 305 in FIG. 3. Thus, the airgap 412 may be formed as part of a production process of the flexible core and/or formed through an etching process, cutting process (e.g., laser cutting), ablation, or any other suitable method. As shown in FIG. 4E, the airgap 412 may include a magnetic paste 408. The magnetic paste 408 may allow the toroidal inductor 407 to be tuned to various applications (e.g., a ferrite bead, noise choke, a voltage regulator, etc.). The magnetic paste 408 may include iron, silver, graphene, cobalt, nickel, and/or any other suitable material. The magnetic paste may provide an additional degree of freedom in managing the trade-offs between inductance and current handling. For example, a weakly-loaded magnetic paste (e.g., relatively few magnetic particles in a polymer paste may enhance inductance without compromising current-handling. Alternatively, a highly-loaded magnetic paste (e.g., relatively many magnetic particles in a polymer paste) may increase the inductance but with lower current handling.

The angled windings 404a-d may include a first arm 406a and a second arm 406b. Although only the angled winding 404c is labelled with the first arm 406a and the second arm 406b, it should be understood that all of the angled windings 404a-d may include a first arm and a second arm. The first arm 406a and second arm 406b may meet to form an angle 416. The angle 416 may be within a range of about 60° to about 120°, inclusive. The first arm 406a and the second arm 406b may increase a surface area of the angled winding 404c and/or the overall length of the angled winding 404c. Thus, the toroidal inductor 403 may exhibit different operating characteristics than other inductors (e.g., operating frequency, inductance, reluctance, etc.).

It should be understood that FIGS. 4A-E are merely provided as examples. Features of any of the toroidal inductors shown in any of FIGS. 4A-E may be combined with the features of any other toroidal inductor. One of ordinary skill in the art would recognize many different configurations and possibilities.

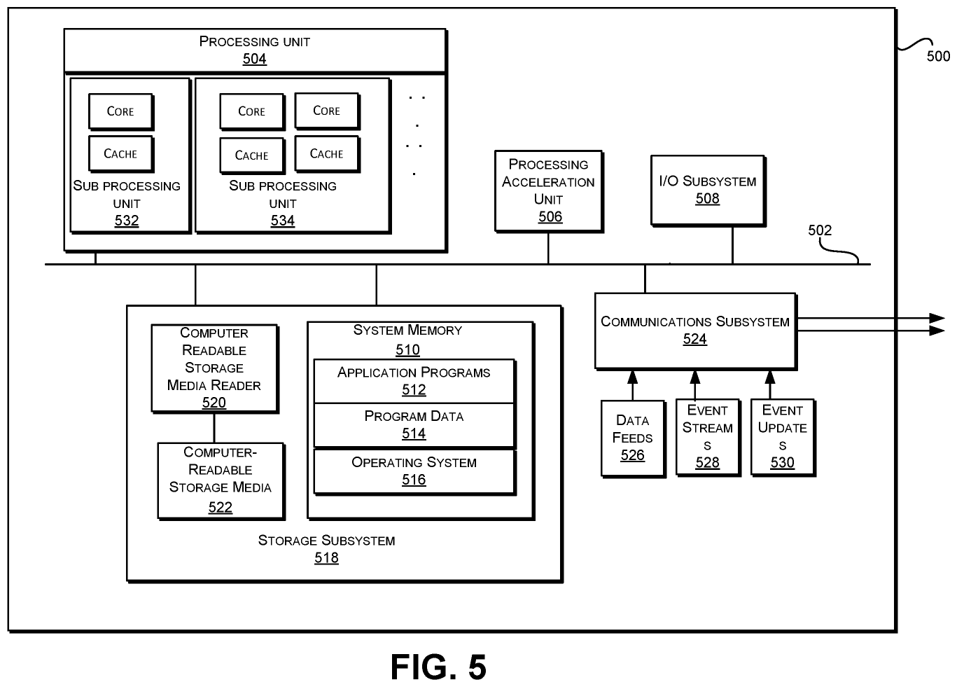

FIG. 5 illustrates an exemplary computer system 500, in which various embodiments may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices that enables users to control and interact with an input device through a natural user interface using gestures and spoken commands. Additionally, user interface input devices may include voice recognition sensing devices that enable users to interact with voice recognition systems through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that comprises software elements, shown as being currently located within a system memory 510. System memory 510 may store program instructions that are loadable and executable on processing unit 504, as well as data generated during the execution of these programs.

Depending on the configuration and type of computer system 500, system memory 510 may be volatile (such as random access memory (RAM)) and/or non-volatile (such as read-only memory (ROM), flash memory, etc.). The RAM typically contains data and/or program modules that are immediately accessible to and/or presently being operated and executed by processing unit 504. In some implementations, system memory 510 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the ROM. By way of example, and not limitation, system memory 510 also illustrates application programs 512, which may include client applications, Web browsers, mid-tier applications, relational database management systems (RDBMS), etc., program data 514, and an operating system 516.

Storage subsystem 518 may also provide a tangible computer-readable storage medium for storing the basic programming and data constructs that provide the functionality of some embodiments. Software (programs, code modules, instructions) that when executed by a processor provide the functionality described above may be stored in storage subsystem 518. These software modules or instructions may be executed by processing unit 504. Storage subsystem 518 may also provide a repository for storing data used in accordance with some embodiments.

Storage subsystem 500 may also include a computer-readable storage media reader 520 that can further be connected to computer-readable storage media 522. Together and, optionally, in combination with system memory 510, computer-readable storage media 522 may comprehensively represent remote, local, fixed, and/or removable storage devices plus storage media for temporarily and/or more permanently containing, storing, transmitting, and retrieving computer-readable information.

Computer-readable storage media 522 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 500.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD or other optical media. Computer-readable storage media 522 may include, but is not limited to, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G, 5G, or EDGE (enhanced data rates for global evolution), WiFi (IEEE 802.5 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

What is claimed is:

1. An inductor, comprising:
a flexible polyimide core comprising one or more cavities;
a magnetic film, formed on two sides of the flexible polyimide flexible core and on a respective sidewall of each of the one or more cavities;
a dielectric layer formed on the magnetic film; and
a metal layer formed on the dielectric layer and within the cavities, such that vias are formed on one or more sides of the inductor and extend through the one or more cavities.

2. The inductor of claim 1, wherein the magnetic film comprises nickel, iron, cobalt, zirconia, and tantalum, hafnium, and silicon.

3. The inductor of claim 1, wherein the magnetic film comprises an oxide of at least one of zirconium, tantalum, hafnium, silicon.

4. The inductor of claim 1, wherein the magnetic film comprises multiple layers of magnetic films and oxide films.

5. The inductor of claim 1, wherein the metal layer and the vias form between two and five turns, inclusive, of the inductor.

6. The inductor of claim 1, further comprising an airgap in the flexible polyimide core, the airgap comprising a width of about 48 micrometers to about 250 micrometers.

7. An inductor, comprising:
a polyimide flexible core;
a magnetic film, deposited on one or more sides of the flexible core;
a dielectric layer; and
a plurality of copper windings.

8. The inductor of claim 7, wherein the magnetic film comprises at least one of cobalt, zirconia, and tantalum.

9. The inductor of claim 7, wherein the magnetic film comprises an oxide layer.

10. The inductor of claim 7, wherein the plurality of copper windings are formed using an electroplating process.

11. The inductor of claim 7, wherein the plurality of copper windings form a toroidal shape.

12. The inductor of claim 11, wherein the toroid comprises an airgap.

13. A method of forming an inductor, comprising:
forming a magnetic film on a flexible core;
forming a dielectric layer on the magnetic film; and
forming a metal layer on at least some of the dielectric layer.

14. The method of claim 13, wherein first vias are formed through the flexible core prior to depositing the magnetic film on the flexible core.

15. The method of claim 14, further comprising forming second vias through the dielectric layer such that depositing the metal layer on at least some of the dielectric layer forms a metal pathway extending through at least one of the flexible core, the magnetic film, and the dielectric layer.

16. The method of claim 14, wherein the first vias comprise a diameter of about 25 micrometers.

17. The method of claim 13, wherein the magnetic film has a thickness of about 10 micrometers.

18. The method of claim 13, wherein the magnetic film, the dielectric layer and a metal seeding layer are sequentially deposited in a same PVD sequence.

19. The method of claim 13, where the flexible core comprises polymide, glass, liquid crystal polymer, and fluoropolymer.

20. The method of claim 13, further comprising forming an airgap in the metal layer, and the airgap is filled with heavily-loaded magnetic paste.
